(19) United States
(12) Patent Application Publication
(10) Pub. No.: US 2023/0369626 A1
(43) Pub. Date: Nov. 16, 2023

(54) FABRICATION OF MEMBRANE ELECTRODE ASSEMBLIES AND REVERSIBLE ELECTROCHEMICAL DEVICES

(71) Applicant: HYDROLITE LTD, Caesarea (IL)

(72) Inventors: Charly David AZRA, Harish (IL); Miles Page, Hod Hasharon (IL); Ervin Tal-Gutelmacher, Hod Hasharon (IL)

(73) Assignee: HYDROLITE LTD, Caesarea (IL)

(21) Appl. No.: 18/224,099

(22) Filed: Jul. 20, 2023

Related U.S. Application Data
(63) Continuation of application No. PCT/IL2022/050091, filed on Jan. 21, 2022.
(60) Provisional application No. 63/221,035, filed on Jul. 13, 2021.
(60) Provisional application No. 63/139,842, filed on Jan. 21, 2021.
(60) Provisional application No. 63/211,186, filed on Jun. 16, 2021.

(51) Int. Cl. H01M 8/14; H01M 8/22; H01M 8/1004; H01M 16/00

(52) U.S. Cl. CPC H01M 8/141; H01M 8/227; H01M 8/1004; H01M 16/003

(57) ABSTRACT

Membrane assemblies for electrochemical devices are provided, along with methods and system for fabricating them. Membrane assemblies comprise anode layer(s) and cathode layer(s), separated by membranous separation layer(s) and all embedded in continuous polymerized ionomer material. In production, during continuous deposition of ionomer material on a substrate (e.g., by electrospinning or electrospraying), consecutive deposition stages of catalyst material and optionally binder material are performed. For example, anode particles, binder material and cathode particles may be deposited (e.g., by electrospraying or electrospinning, respectively) consecutively during the continuous deposition o the ionomer material. Self-refueling power-generating system are provided, which include reversible anion exchange membrane devices with disclosed membrane assemblies.

### CROSS REFERENCE TO RELATED APPLICATIONS

This Application is a continuation of PCT Application No. PCT/IL2022/050091 filed on Jan. 20, 2022, which claims the priority from U.S. Patent Application No. 63/139,842, filed Jan. 21, 2021, U.S. Patent Application No. 63/211,186, filed Jun. 16, 2021, and U.S. Patent Application No. 63/221,035, filed Jul. 13, 2021, all of which are hereby incorporated by reference in their entirety.

### BACKGROUND OF THE INVENTION

### 1. Technical Field

The present invention relates to the field of electrochemical devices, and more particularly, to membrane assemblies for electrolyzers and for fuel cells, and optionally for reversible devices.

### 2. Discussion of Related Art

Electrolyzers and fuel cells are electrochemical devices used to electrolyze water to generate hydrogen (e.g., as fuel) and to generate electricity from fuel (e.g., hydrogen), respectively.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides a membrane assembly for an electrochemical device, the membrane assembly comprising at least an anode layer, a separation layer and a cathode layer that are all embedded in continuous polymerized ionomer material.

One aspect of the present invention provides a method of producing a membrane assembly for an electrochemical device, the method comprising: continuously depositing ionomer material on a substrate, and during the continuous depositing of the ionomer material, depositing in consecutive steps anode material, optionally separator material and cathode material, wherein the continuous deposition and the consecutive deposition steps are configured to embed in continuous polymerized ionomer material the anode material and the cathode material, separated by a separation layer.

One aspect of the present invention provides a system of fabricating membrane assemblies for an electrochemical device, the system comprising: at least one deposition unit configured to continuously deposit ionomer material on a substrate, and at least one deposition unit configured to deposit in consecutive steps, during the continuous depositing of the ionomer material: anode material, optionally separator material and cathode material, wherein the continuous deposition and the consecutive deposition are configured to embed the anode material and the cathode material, separated by a separation layer—in continuous polymerized ionomer material.

One aspect of the present invention provides a self-refueling power-generating system comprising a reversible anion exchange membrane (AEM) device with the membrane assembly, configured to be operated alternately as a fuel cell and as an electrolyzer.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high-level schematic illustration of electrochemical devices, according to some embodiments of the invention.

FIG. 2 is a high-level schematic illustration of membrane assemblies and production methods thereof, according to some embodiments of the invention.

FIGS. 3 and 4 are high-level schematic illustrations of membrane assemblies in cross section, according to some embodiments of the invention.

FIG. 5 is a high-level block diagram illustrating fabrication systems, according to some embodiments of the invention.

FIGS. 6A and 6B are high-level schematic illustrations of deposition apparatuses in the systems, according to some embodiments of the invention.

FIG. 7 is a high-level flowchart illustrating fabrication methods, according to some embodiments of the invention.

FIG. 8 is a high-level schematic illustration of a self-refueling power-generating system with reversible AEM devices, according to some embodiments of the invention.

FIG. 9 is a high-level flowchart illustrating a method of operating self-refueling power-generating systems, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Embodiments of the present invention provide efficient and economical methods and mechanisms for fabricating membrane assemblies for electrochemical devices and thereby provide improvements to the technological field of electrolyzers and fuel cells. Membrane assemblies for electrochemical devices are provided, along with methods and system for fabricating them. Membrane assemblies comprise anode layer(s) and cathode layer(s), separated by membranous separation layer(s) and all embedded in continuous polymerized ionomer material. In production, during continuous deposition of ionomer material on a substrate (e.g., by electrospinning or electrospraying), consecutive deposition stages of catalyst material and optionally binder material are performed. For example, anode particles, binder material and cathode particles may be deposited (e.g., by electrospraying or electrospinning, respectively) consecutively during the continuous deposition o the ionomer material. Self-refueling power-generating systems are provided, which include reversible anion exchange membrane devices with disclosed membrane assemblies.

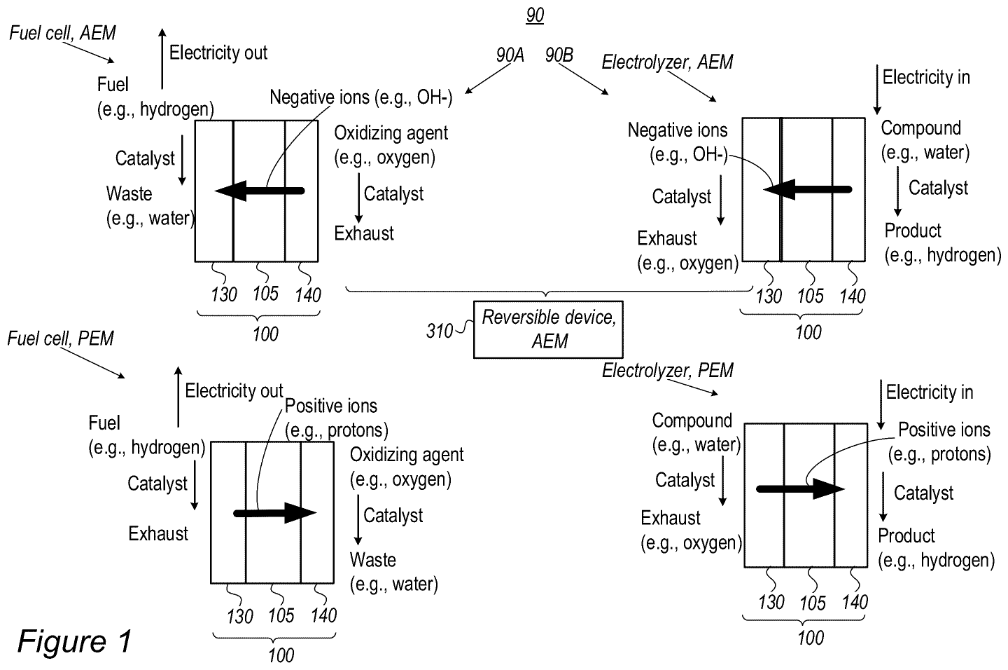

FIG. 1 is a high-level schematic illustration of devices 90, according to some embodiments of the invention. Disclosed membrane assemblies 100 and separation layer(s) 105 may be used for devices 90 such as fuel cells 90A and electrolyzers 90B, for which the principles of operation are briefly described. As non-limiting examples, implementations fuel cells 90A and electrolyzers 90B with AEM (anion exchange membranes) and PEM (proton exchange membranes) are illustrated in a highly schematic manner. Devices 90 typically have anodes 130 and cathodes 140 with corresponding catalysts that catalyze the respective reactions, as described briefly herein.

Fuel cells 90A are electrochemical cells that generate electricity (denoted schematically as “electricity out”) using a fuel (e.g., hydrogen) and an oxidizing agent (e.g., oxygen). In the case of hydrogen AEM fuel cells 90A, the hydrogen fuel is oxidized by hydroxide (OH⁻) anions formed at cathode side 140 from a reaction of water with oxygen, and moving through separation layers 105 to anode side 130, releasing electrons that travel through an external circuit to the cathode, thereby providing electrical power, as well as product water. In hydrogen PEM fuel cells 90A, the hydrogen is oxidized at anode side 130, releasing electrons that travel through an external circuit to the cathode, thereby providing electrical power, and protons which move through separation layers 105 to cathode side 140 where they combine with oxygen to form product water.

Electrolyzers 90B are electrochemical cells that use electricity (denoted schematically as “electricity in”) to break down compounds (e.g., water) to yield products (e.g., hydrogen or other compounds). In AEM water electrolyzers 90B (including ones working with alkaline water, e.g., water with KOH), electricity is used to break down water to form hydrogen gas at cathode side 140, as well as hydroxide (OH⁻) anions that move through separation layers 105 to anode side 130, where they are reacted to form oxygen and water. In PEM electrolyzers 90B, water is broken down at anode side 130 to yield oxygen gas and cations (e.g., protons) that move through separation layers 105 to form hydrogen gas at cathode side 140.

Electrolyzers 90B are typically used to generate hydrogen for storage a future use, e.g., in fuel cells 90A. Often, similar technologies are used for fuel cells 90A and electrolyzers 90B, with varying specifications of the respective components to optimize the respective device. Certain devices 90 may be configured to operate as reversible fuel cells, namely devices 90 may be operated alternatively, or alternately, as fuel cells 90A and electrolyzers 90B. Devices 90 may comprise any type of fuel cell 90A or electrolyzer 90B, including non-hydrogen fuel cell 90A or non-hydrogen electrolyzer 90B. Moreover, devices 90 may comprise other types of electrochemical synthesizers, such as chlor-alkali plants for the electrolysis of sodium chloride solutions, electrochemical synthesis of hydrogen peroxide (14202), etc., which may comprise disclosed membrane assemblies 100 and separation layer(s) 105 as well. Unless stated otherwise, disclosed membrane assemblies 100 and separation layer(s) 105 may be used in either type of device 90, by adjusting the implementation details such as dimensions (especially thickness), materials and internal structure, as disclosed herein.

Fuel cells 90A and/or electrolyzers 90B may further comprise gas diffusion layers (GDLs) that allow gases and/or fluids through. Membrane assemblies 100 may comprise separation layer(s) 105, optionally one or both anode(s) 130 and cathode(s) 140 and optionally also corresponding gas diffusion layers. For example, membrane assemblies 100 may be configured to operate as membrane-electrode assemblies (MEAs) that are the core components of proton-exchange membrane fuel cells (PEMFCs) and proton-exchange membrane electrolyzers (PEMELs); as well as of anion-exchange membrane fuel cells (AEMFCs) and anion-exchange membrane electrolyzers (AEMELs). Membrane assemblies 100 may be manufactured separately from the electrodes, or one or even both electrodes 130, 140 may be deposited on membrane assembly 100 itself, forming respective catalyst-coated membranes (CCM). Alternatively or complementarily, the catalyst layers may be deposited on gas-diffusion layers (GDLs), forming gas diffusion electrodes (GDEs) that are pressed against membrane assembly 100 to form the respective stacks.

Reversible AEM devices 310 may be operated as either fuel cells 90A and/or electrolyzers 90B, depending on their operation conditions and material and energy flows. Power flow, and flows of hydrogen, oxygen and water may be reversed upon switching the operation mode of reversible AEM devices 310 and layer properties of reversible AEM devices 310 may be selected to operate effectively in both modes, as disclosed herein. Separation layer(s) 105 may comprise one or more sheet(s) that may range in thickness from a few μm, through tens of μm and up to one or two hundred μm. Separation layer(s) 105 may comprise multiple thin sheets, some thin and some thicker sheets, or any operable combination of number and thickness of the sheets, reaching an overall thickness of up to 200 μm. The sheets of separation layer(s) 105 may be configured to combine high ionic conductivity, water transportability, mechanical strength and stability, and low gas permeation, and be optimized respectively as disclosed herein. For example, one or more sheets of separation layer(s) 105 may be configured to support other, main separation sheet(s) of separation layer(s) 105. The supporting sheets in separation layer(s) 105 may be very thin, e.g., hundreds of nanometers thick, tens of nm thick or even 10 nm, 5 nm or less in thickness, possibly down to the thickness of ceramic particles embedded therein themselves.

In various embodiments, separation layer(s) 105 may comprise ionomer membranes, membranes that incorporate ionic particles, and/or stabilizing structures such as mesh supports or particles, which may also limit membrane swelling upon water uptake. The thickness and order of multiple separation layers 105 may be configured to optimize the parameters required for each type of device 90 and respective performance requirements. Membrane assemblies 100 may include several functional separation layers 105, and may be manufactured in different ways, e.g., by multi-layer deposition upon any substrate (including e.g., GDL(s), GDE(s), catalyst layers as CCMs, etc.) or by attaching of multiple supported and/or unsupported layers of separation layer(s) 105, as disclosed herein.

Separation layer(s) 105 are configured to provide a gas-tight separation between electrodes 130, 140 and to conduct ions and transfer water between electrodes 130, 140. Separation layer(s) 105 are configured to have high ionic conductance to limit ohmic losses and high water permeance to limit device dry-out, e.g., by using high quality ionomers and/or by decreasing membrane thickness—either by reaching the limit for ultra-thin freestanding membranes or by using membranes supported by meshes, which however reduce the amount of available ionomer, yielding a tradeoff between the components contributing to ionic conductivity. Disclosed separation layer(s) 105 and membrane assemblies 100 are characterized by a combination of high ionic conductivity and mechanical strength,

Membrane assemblies 100 may be designed to optimize the performance of devices 90 by adjusting the architecture of the electrodes to support the respective electrochemical and physical processes. For example, membrane assemblies 100 may be configured to assure percolation through the ionomer-rich phase to ensure ionic transport through membrane assembly 100 as a whole. Membrane assemblies 100 may further be configured to manage water transport within the ionomer, and to form, by configuration of the catalyst and support particles, a percolation network that provides electronic conductivity. Membrane assemblies 100 may further be configured to locate the catalyst particles accurately at the ionomer-pore interfaces, forming a three-phase interface, to support the catalytic processes (e.g., avoiding fully covering catalyst particles by ionomer and setting the catalyst particles close to the ionomer phase). Membrane assemblies 100 may be porous in order to provide a path for the gas reactants.

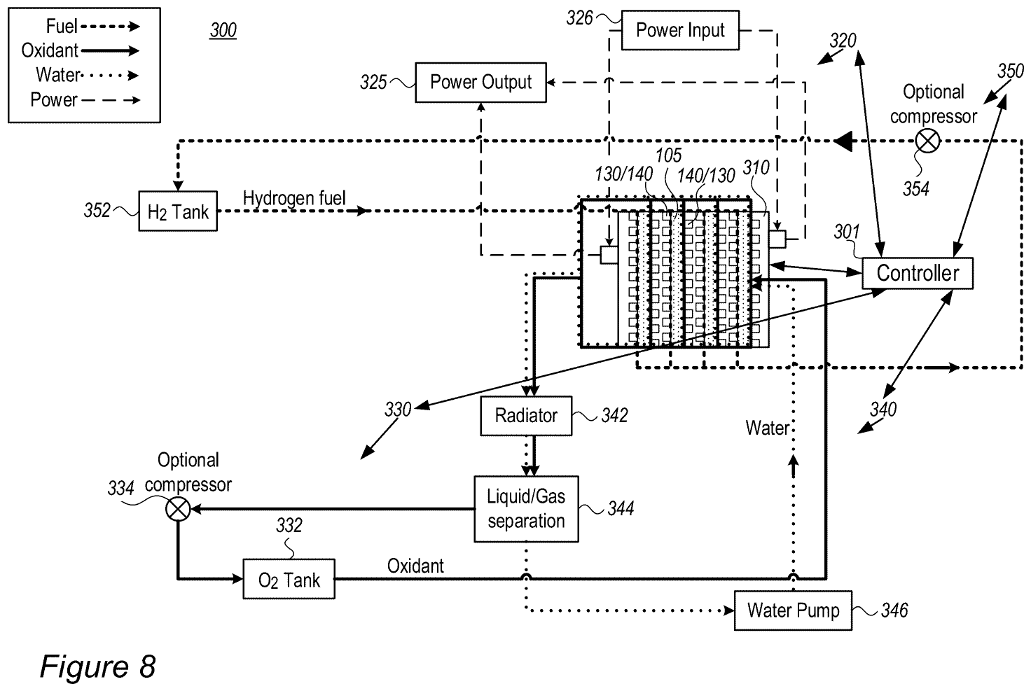

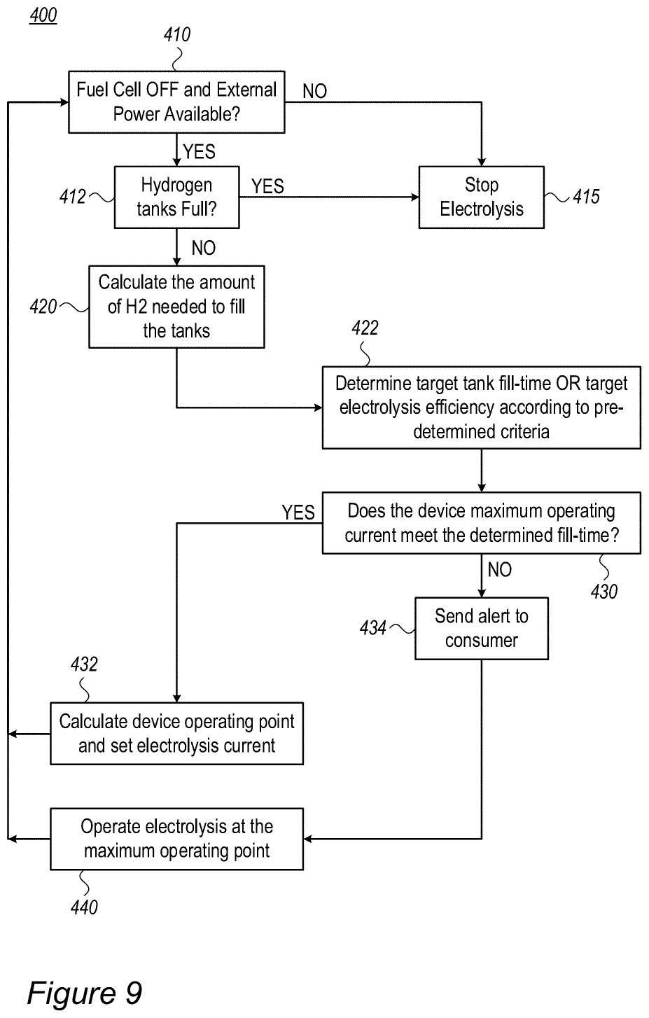

In various embodiments, membrane assemblies 100 may be designed to be part of a reversible device which comprises one or more electrochemical cells that can function both as fuel cell 90A and as electrolyzer 90B, depending on inputs and control of the reversible device. Disclosed separation layer(s) 105 membrane assemblies 100 may be optimized to enable efficient operation of reversible devices 310 in both fuel cell and electrolyzer modes. Examples for reversible devices 310 in self-refueling power-generating systems 300 and their operation schemes 400 are provided in FIGS. 8 and 9 and the related description below—for example, systems 300 may use reversible AEM cell stacks 310, which are configured to be operated alternately as fuel cell 90A and as electrolyzer 90B. Membrane assemblies 100 may be used in any type of reversible device, such as prior art reversible devices and/or disclosed reversible devices that are taught, e.g., by U.S. Provisional Applications Nos. 63/211,186 and 63/221,035, filed on Jul. 13, 2021, which are incorporated herein by reference in their entirety.

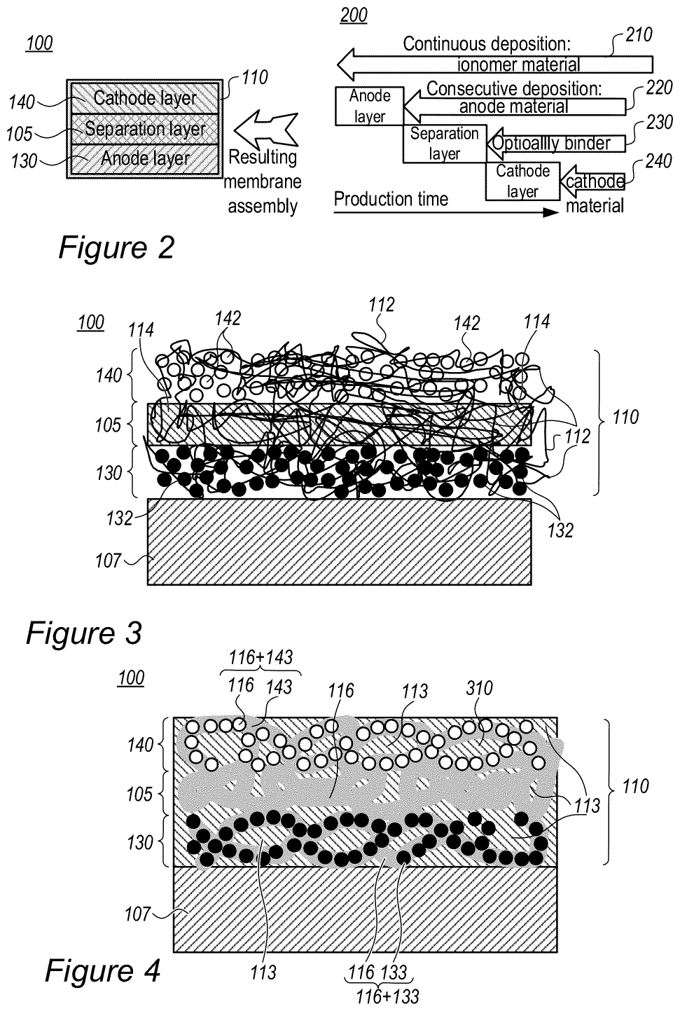

FIG. 2 is a high-level schematic illustration of membrane assemblies 100 and production method 200 thereof, according to some embodiments of the invention. Disclosed membrane assemblies 100 may be used for electrochemical devices 90, such as electrolyzers 90B and/or fuel cells 90A. Membrane assemblies comprise at least anode layer 130, separation layer 105 and cathode layer 140 that are all embedded in continuous polymerized ionomer material 110 (illustrated schematically overlapping and throughout layers 130, 105, 140, with narrow margins that are optional and illustrated mainly for clarity of the explanation). Production method 200 of producing membrane assemblies 100 may comprise continuous depositing ionomer material on a substrate (stage 210), and during continuous depositing 210 of the ionomer material—depositing in consecutive steps anode material (step 220), optionally separator material (step 230) and cathode material (step 240), wherein continuous deposition 210 and consecutive deposition steps 220, 230, 240 are configured to embed in continuous polymerized ionomer material the anode material and the cathode material, separated by separation layer 105 that may comprise only the ionomer material and/or optionally additional binder material. It is noted that the order of the layers may be reversed, e.g., first depositing cathode layer 140, then separation layer 105 and then anode layer 130, and/or multiple sets of layers may be deposited in a single process. Membrane assemblies 100 may be attached to corresponding substrate (e.g., GDL) on either or both sides, contacting anode layer 130 and/or cathode layer 140.

FIGS. 3 and 4 are high-level schematic illustrations of membrane assemblies 100 in cross section, according to some embodiments of the invention. The illustration of the order of layers and attachment of anode layer 130 to a GDL 107 are non-limiting, as the order of the layers may be reversed and cathode layer 140 may be attached to GDL 107.

In certain embodiments (see, e.g., FIG. 3), ionomer material 110 may comprise electrospun nanofibers 112 (illustrated schematically), anode layer 130 may comprise electrosprayed (anode) catalyst particles 132 (illustrated schematically) and cathode layer 140 may comprise electrosprayed (cathode) catalyst particles 142 (illustrated schematically). In certain embodiments, separation layer 105 may be made only of ionomer material 110, while in certain embodiments, membrane assemblies 100 may further comprise binder droplets 114 (illustrated schematically as bulk material), e.g., forming at least part of separation layer 105 and optionally at least parts of anode layer 130 and/or cathode layer 140, together with ionomer material 110. Polymerized ionomer material 110, without or with binder droplets 114 may be configured to consolidate membrane assembly 100.

In certain embodiments (see, e.g., FIG. 4), ionomer material 110 may comprise electrosprayed droplets 113 (illustrated schematically as bulk material), anode layer 130 may comprise electrospun (anode) catalyst nanofibers 133 (illustrated schematically) and cathode layer 140 may comprise electrospun (cathode) catalyst nanofibers 143 (illustrated schematically). In certain embodiments, separation layer 105 may be made only of ionomer material 110, while in certain embodiments, membrane assemblies 100 may further comprise electrospun binder nanofibers 116 (illustrated schematically), e.g., forming at least part of separation layer 105 and optionally at least parts of anode layer 130 and/or cathode layer 140, together with ionomer material 110. Polymerized ionomer material 110, without or with binder nanofibers 116 may be configured to consolidate membrane assembly 100. Anode and/or cathode catalyst nanofibers 133, 143 (respectively) may be electrospun together with binder nanofibers 116, as illustrated schematically.

In certain embodiments, both ionomer material 110 and catalyst material (of anode 130 and/or of cathode 140) may be electrospun and comprise fibers and/or nanofibers. Alternatively or complementarily, catalyst particles may be carried by a polymer matrix, such as ionomer material 110 and/or precursor(s) of ionomer material 110, dispersed in a solvent. The polymer may be electrospun to form polymer (e.g., ionomer) nanofibers that are loaded with catalyst particles that provide catalysis and electrical conductivity. For forming anode 130 the catalyst particles may comprise anode particles 132, and for forming cathode 140 the catalyst particles may comprise cathode particles 142.

In certain embodiments, both ionomer material 110 and catalyst material (of anode 130 and/or of cathode 140) may be electrosprayed. In certain embodiments, catalyst material (of anode 130 and/or of cathode 140) may be electrosprayed while ionomer material 110 may be electrospun or electrosprayed to form separation layer 105 and to hold the electrosprayed catalyst particles integrally attached to separation layer 105 by ionomer material 110.

In various embodiments, catalyst layers (anode 130 and/or cathode 140) are porous, electrically conductive and ionically conductive; and have a thickness between 1 μm and 100 μm, e.g., 10 μm, 30 μm, 50 μm or other intermediate values. Separation layer 105 may be non-porous, have a very low hydrogen and oxygen permeability, high conductance (e.g., >10 S·cm⁻² for a fuel cells 90A or >5 S·cm⁻² for electrolyzers 90B) and water permeance, and may range in thickness between 5 μm and 200 μm depending on application and material properties of ionomer material 110. Typically, but not necessarily, separation layer 105 in electrolyzers 90B may be thicker than in fuel cells 90A. For example, a fuel cell membrane (separation layer 105) may be between 5 μm and 50 μm in thickness, whereas an electrolyzer membrane (separation layer 105) may be between 15 μm and 200 μm in thickness. The choice of catalyst materials and the optimization of the catalyst-to-ionomer material ratios may be different in electrolyzers 90B, fuel cells 90A and reversible devices.

Non-limiting examples for specific configurations of fuel cells 90A, electrolyzers 90B and reversible devices as combinations thereof are provided herein and in Table 1. It is noted that any of the layers may also include various additives to optimize its performance and stability.

AEM fuel cells 90A may be configured with anode (hydrogen oxidation) catalyst layer 130 that is between 2-30 microns thick, contains between 5% w/w and 40% w/w ionomer material 110 and includes catalyst material comprising any of the following or their combinations: Pt, a Pt—Ru alloy or combination, optionally carbon-supported; Pd activated with nickel, cerium oxide, ruthenium or ruthenium oxide, or other oxophilic material, optionally carbon-supported; carbon activated by doping with nitrogen or metallic elements; or any other hydrogen oxidation catalyst. Separation layer 105 may comprise (i) a 10-30 micron-thick membrane of conductance >10 S·cm⁻² comprising ionomer, optionally cross-linked, or (ii) a 5-20 micron-thick membrane of conductance >10 S·cm⁻² comprising a blend of an ionomer, optionally crosslinked, and an inert porous matrix material. Cathode (oxygen reduction) layer 140 may be 10-30 micron thick, contain between 1% w/w and 40% w/w ionomer material 110, and catalyst material comprising any of the following or their combinations: Ag, Pd, various transition metal oxides or mixed oxides, optionally on a carbon support; metal and/or N-doped carbon, or other oxygen reduction catalyst.

AEM electrolyzers 90B may be configured with anode (oxygen evolution) catalyst layer 130 that is between 5-50 micron thick, contains a catalyst material comprising one or more of metallic nickel, iron, iridium, or platinum, or oxides thereof; and optionally contains ionomer material. Separation layer 105 may comprise a (i) 15-100 micron-thick membrane of conductance >5 S·cm⁻² comprising ionomer, optionally cross-linked, or (ii) 10-70 micron-thick membrane of conductance >5 S·cm⁻² comprising a blend of an ionomer, optionally crosslinked, and an inert porous matrix material. Cathode (hydrogen evolution) layer 140 may be 1-20 micron thick and contain a catalyst material comprising any of the following or their combinations: Pt, Ru, Pd, Ir, or their alloys or combinations, optionally activated with nickel, cerium oxide, ruthenium or ruthenium oxide, or other oxophilic material, optionally carbon-supported; or carbon activated by doping with nitrogen or metallic elements; or other hydrogen evolution catalyst; and optionally containing a portion of ionomer material 110.

Reversible MEA devices 310 may comprise any combination of the above properties for each layer, with the oxygen-active layer comprising catalysts to perform both the oxygen evolution and oxygen reduction processes; the hydrogen-active layer to perform both the hydrogen reduction and hydrogen oxidation processes. The membrane could be configured as the fuel cell membrane to optimize the fuel cell performance, which then limits the ability of the device to self-pressurize in electrolyzer mode, or as the electrolyzer membrane to achieve pressurizability but at a cost to fuel cell performance, or some intermediate configuration to allow both operations to be moderately optimized. For example, anode layer 130 may be between 5 μm and 30 μm thick and may be made of metallic Ni and/or Pt, and/or oxides thereof and/or other oxophilic material, separation layer 105 may be between 10 μm and 30 μm thick, and have a conductance larger than 10 S·cm⁻², and cathode layer 140 may be between 10 μm and 20 μm thick and may be made of oxophilic material. It is noted that in reversible device 310, the electrode operating as anode 130 in the fuel cell mode (90A) operates as cathode 140 in the electrolyzer mode (90B) and the electrode operating as cathode 140 in the fuel cell mode (90A) operates as anode 130 in the electrolyzer mode (90B). For example, in reversible device 310, the former electrode may be 2 μm to 20 μm thick and made of oxophilic material, while the latter may be 10 μm to 30 μm thick and is made of oxygen reducing material, with separation layer 105 being 10 μm to 30 μm thick, and with a conductance larger than 10 S·cm⁻².

TABLE
Non-limiting examples for membrane and cell configurations.

| | | Reversible device* - a combination of: | |
|---|---|---|---|
| Component | Characteristic | AEM fuel cell | AEM electrolyzer |
| Anode | Thickness | 2 μm to 30 μm | 5 μm to 50 μm |
| catalyst layer | Ionomer | 5% w/w to 40% w/w | Optional |
| 130 | content | | |
| (hydrogen | Catalyst | Oxophilic material, | Metallic Ni, Fe, Ir, or Pt, or |
| oxidation in | material | optionally carbon- | oxides thereof |
| fuel cells, | | supported, or other hydrogen | |
| oxygen | | oxidation catalyst. | |
| evolution in | | For example: Pt, a Pt—Ru | |
| electrolyzers) | | alloy or combination; Pd | |
| | | activated with Ni, Ce oxide, | |
| | | Ru or Ru oxide; carbon | |
| | | activated by doping with N | |
| | | or metallic elements. | |
| Separation | Thickness | 10 μm to 30 μm, or | 15 μm to 100 μm, or |
| layer 105 | | 5 μm to 20 μm | 10 μm to 70 μm |
| (membrane) | Conductance | >10 S · cm⁻² | >5 S · cm⁻² |
| | Material | Ionomer, optionally cross-linked, optionally with inert | |
| | | porous matrix material | |
| Cathode | Thickness | 10 μm to 30 μm | 1 μm to 20 μm |
| catalyst layer | Ionomer | 1% w/w to 40% w/w | Optional |
| 140 (oxygen | content | | |
| reduction in | Catalyst | Ag, Pd, various transition | Oxophilic material, |
| fuel cells, | material | metal oxides or mixed | optionally carbon- |
| hydrogen | | oxides, optionally on a | supported, or other |
| evolution in | | carbon support; metal and/or | hydrogen evolution catalyst. |
| electrolyzers) | | N-doped carbon, or other | For example: Pt, Ru, Pd, Ir, |
| | | oxygen reduction catalyst | or their alloys or |
| | | | combinations, optionally |
| | | | activated with Ni, Ce oxide, |
| | | | Ru or Ru oxide; or carbon |
| | | | activated by doping with N |
| | | | or metallic elements. |

*In reversible devices, the electrode operating as anode 130 in the fuel cell mode (90A) operates as cathode 140 in the electrolyzer mode (90B) and the electrode operating as cathode 140 in the fuel cell mode (90A) operates as anode 130 in the electrolyzer mode (90B).

Examples for ionomer material 110 include continuous anion conducting ionomer (for AEM implementations) comprising, e.g., polymers or copolymers of (vinylbenzyl)trimethylammonium chloride, or other quaternary ammonium halide, wherein the halide counterion may be exchanged to any desired anion, copolymers of diallyldimethylammonium chloride (DADMAC), wherein the counterion may be exchanged to any desired anion, styrene-based polymers having quaternary ammonium anion conducting group, quaternized poly(vinylalcohol) (QPVA), bi-phenyl or tri-phenyl backboned polymers with one or more functional groups that could include alkyl tether group(s) and/or alkyl halide group(s) and/or equivalent groups, poly(arylpiperidinium) and other polymers containing cyclic quaternary ammonium in the backbone or on tethered sidechains, poly(bis-arylimidazoliums), cation-functionalized poly(norbornenes), neutral polymers or polymer membranes with grafted anion-conductive sidechains, or any other anion-conducting polymer. In some embodiments, the anion conducting ionomer may be crosslinked, e.g., using crosslinking agent(s) selected according to the type of the ionomer to be crosslinked, such as divinylbenzne, N,N,N′,N′-tetramethyl-1,6-hexanediamine (TMHDA), 1,4-diazabicyclo[2.2.2]octane (DABCO), glyoxal, glutaraldehyde, styrene based polymer(s) having quaternary ammonium anion conducting group(s), bi-phenyl or tri-phenyl backboned polyarylenes with one or more functional groups that could include alkene tether group(s) and/or alkyl halide group(s) and/or equivalent groups, hydrocarbon chains, sulfur groups, siloxy groups, N-hydroxybenzotriazole groups, azide groups and the like. In some embodiments, the anion conducting ionomer may be a blend of several polymers, some of which may not be anion conducting. In some embodiments, the membrane-electrode assembly production may be performed using precursor polymers that can be treated post-production with reactive agents to form the ion-conducting, charged, functional groups. Examples for ionomer material 110 include cation conducting ionomer (for PEM implementations) comprising, e.g., poly(aryl sulfones), perfluorinated polysulfonic acids such as Nation®, polymers or copolymers of styrene sulfonic acid with various modifications, sulfonated polyimides, phosphoric acid-doped poly(benzimidazole), sulfonated poly(arylene ethers) such as sulfonated poly (ether ether ketone) (SPEEK) and/or other synthetic or natural cation exchange ionomers. In some embodiments, the cation conducting ionomer may be a blend of several polymers, some of which may not be cation conducting.

Examples for catalyst (anode and/or cathode) materials include inks comprising nanoparticles of any of Pt, Pd, Ru, Ni, Fe, Co, Ag, Zr, Mo, Mn, Nb, e.g., as nanocrystals, in one or more of their metallic, metal alloy, metal oxide or mixed-metal oxide configurations, and in either unsupported or supported state, e.g., on carbon or other conductive particles, which may be dispersed in solvent(s) or solution(s), e.g., of ionomer material 110. Examples for binder material include, e.g., solutions of polymers and/or monomers, oligomers thereof, such as polytetrafluoroethylene (PTFE), polyvinylidene fluoride or polyvinylidene difluoride (PVDF), cellulose, polybenzimidazole (PBI), poly(vinyl alcohol) (PVA), polytetrafluoroethylene (PTFE), Nafion, Poly(acrylic acid) (PAA), hyperbranched polymers (HBPs) or the like.

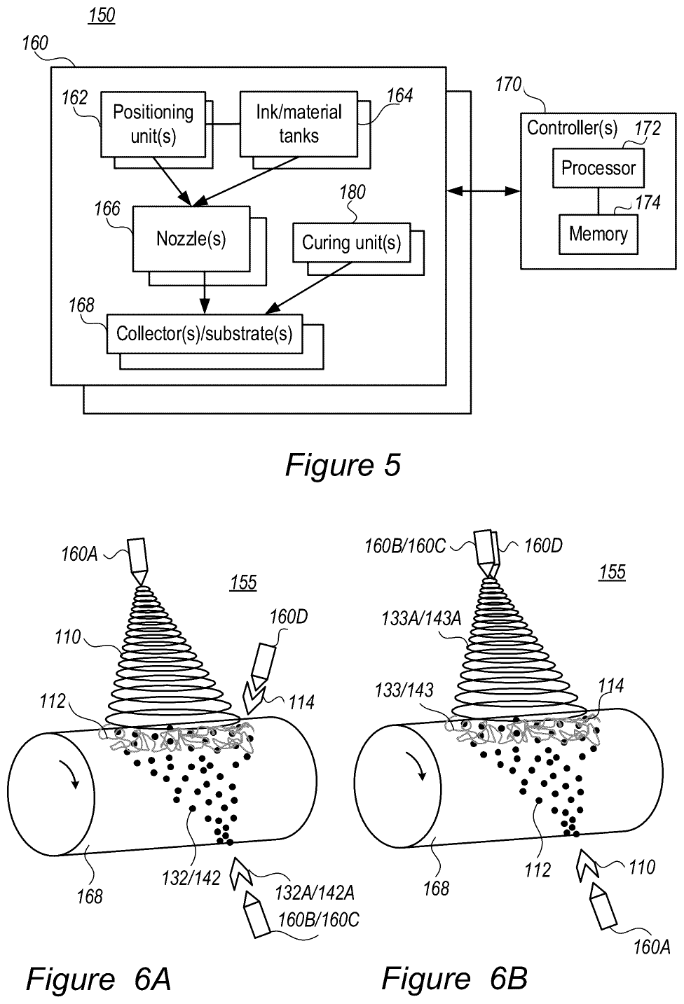

FIG. 5 is a high-level block diagram illustrating a system 150, according to some embodiments of the invention. System 150 is configured to fabricate membrane electrode assemblies 100. System 150 may comprise a plurality of deposition units 160, one or more controller 170 and optionally a curing unit 180. Any one of deposition units 160 may include at least one nozzle 164, respectively, and at least one tank 166, respectively, for holding respective ink(s) or dispersion(s). In some embodiments, deposition units 160 may further include positioning units 162 for positioning and moving nozzles 164 to where the deposition of the ink or the dispersion is required. Positioning units 162, nozzles 164 and tanks 166 may be controlled by one or more controller(s) 120. System 150 may further comprise at least one collector 168 or substrate 168 onto which one or more respective materials are deposited.

In some embodiments, one or more of deposition units 160 may include electrospinning deposition unit(s) configured to deposit long continuous fibers and/or nanofibers. Electrospinning deposition may include a high-voltage power source configured to apply an electric field between respective nozzle 164 and respective collector 168. Electric fields in the range of 0.1 to 10 kV/cm may be used to induce electrospinning.

In some embodiments, one or more of deposition units 160 may include electro-spraying deposition unit(s) configured to deposit domains (e.g., droplets and/or short non-fibers) of respective materials. Electro-spraying and/or electro-spinning deposition may include a high-voltage power source to apply an electric field between the respective nozzle and a respective collector. Electric fields in the range of 0.1 to 10 kV/cm may be used to induce electro-spraying and/or electro-spinning, depending on the fiber-forming capability of the applied materials.

Controller(s) 170 may comprise any controller that may be configured to control various units of the deposition apparatus of system 150, for example, electro-spraying and/or electrospinning deposition units simultaneously to deposit at least two different materials. Controller(s) 170 may be configured to control at least the flow rate and/or deposited amount of the respective deposited material, the location onto which the material is being deposited, the temperature of the deposited material and the like. Controller(s) 170 may further be configured to control the movement of the respective substrate and/or collector onto which the respective materials are being deposited (e.g., a rotation drum collector, a movable flat plate collector, or multiple collector configurations). In some embodiments, controller(s) 170 may further be configured to control curing unit(s) 180 configured to cure (e.g., by crosslinking, post-process amination or other functionalization reactions) the ionomer materials and/or the binder material and/or the catalyst materials after the deposition process, for example, by applying UV radiation, heat exposure to reactive agents or solvents, etc.

Controller(s) 170 may include one or more processors 172 that may comprise any type of processing unit and one or more memory unit(s) 174. Memory 174 may include codes or instructions for controlling at least some of the various components of system 150. For example, codes or instructions stored in memory 174 may be executed by processor 172 according to some methods of the invention disclosed herein.

FIGS. 6A and 6B are high-level schematic illustrations of deposition apparatuses 155 in system 150, according to some embodiments of the invention. FIGS. 6A and 6B depict non-limiting examples for deposition apparatuses 155 which may be part of systems 150 and be used to at least partly fabricate membrane electrode assemblies 100.

For example, as illustrated schematically in FIG. 6A, deposition units 160 may comprise one or more electrospinning deposition units 160A for depositing ionomer material 110 as long continuous ionomer fibers 112 and/or one or more electro-spraying deposition units 160B, 160C configured to deposit anode material 132A and/or cathode material 142A in domains such as short fibers and droplets forming anode particles 132 and/or cathode particles 142, forming membrane electrode assemblies 100 such as illustrated in FIG. 3 (illustrating schematically the resulting microstructure). Optionally, binder material may also be deposited as binder material droplets 114 by electro-spraying deposition unit 160D (shown schematically) to add binder material to membrane electrode assemblies 100 as disclosed herein. The continuous fibers and/or domains may be deposited on one or more carrier or collector 168, such as a rotating drum collector, a movable flat plate collector, or combinations thereof. Resulting fiber diameter may be a few microns, e.g., between 1 μm and 10 μm, e.g., 2 μm, 5 μm, 8 μm or other intermediate values. Fiber length may be not limited, as disclosed technologies allow producing very long single-spun fibers (illustrated schematically in FIGS. 3, 4, 6A and 6B).

In another example, as illustrated schematically in FIG. 6B, deposition units 160 may comprise one or more electrospraying deposition units 160A for depositing ionomer material 110 as ionomer domains, droplets or particles 112 and/or one or more electrospinning deposition units 160B, 160C configured to deposit anode material 133A and/or cathode material 143A in long fibers or nanofibers forming anode layer 130 and/or cathode layer 140, to yield membrane electrode assemblies 100 such as illustrated in FIG. 4 (illustrating schematically the resulting microstructure). Optionally, binder material may also be deposited as binder material fibers 116 by electrospinning deposition unit 160D (shown schematically) to add binder material to membrane electrode assemblies 100 as disclosed herein. The continuous fibers and/or domains may be deposited on one or more carrier or collector 168, such as a rotating drum collector.

It is noted that droplet deposition may be followed by partial or full drying of solvent material (e.g., by evaporation), possibly during the time of flight from nozzle 166 to collector 168, to form solid nanoparticles. When dispersed in the ionomer viscous liquid, respective droplets may impregnate into the ionomer's net. Electro-spraying deposition may result in a continuous matrix phase, into which fibers are incorporated. Electrospinning deposition may result in a continuous fiber net phase, into which droplets of particles are incorporated. Any of the resulting microstructures may be configured to have continuous channels through fabricated membrane assembly 100 (e.g., through electrodes 130, 140 and separation layer 105), enhancing the transport of ions and water between electrodes 130, 140. Curing (e.g., through heating and/or radiation, e.g., using ultraviolet illumination) may be applied to stabilize the deposited polymers in the structures, e.g., by crosslinking.

Resulting membrane electrode assemblies may include a continuous phase having the same ionomer chains connecting together cathode 140, separation layer 105 and anode 130. Anode 130 and cathode 140 may include corresponding catalytic particles and separation layer 105 may include binder material for providing mechanical strength to membrane assembly 100. Entire membrane assembly 100 may be manufactured in a single continuous deposition run that may include continuous deposition of the ionomer material.

In some embodiments, the continuous deposition run may be divided into three sub-steps each including depositing at least one additional material simultaneously with the ionomer. In a first sub-step catalyst particles of a first electrode may be deposited on a substrate (e.g., on a GDE or GDL) to form the first electrode (e.g., anode 130 or cathode 140). In a second sub-step binder material may be deposited, on the first electrode, simultaneously with the ionomer to form the membrane (separation layer 105). In a third sub-step catalyst particles of a second electrode may be deposited on the membrane (separation layer 105), simultaneously with the ionomer to form the second electrode (e.g., cathode 140 or anode 130, respectively).

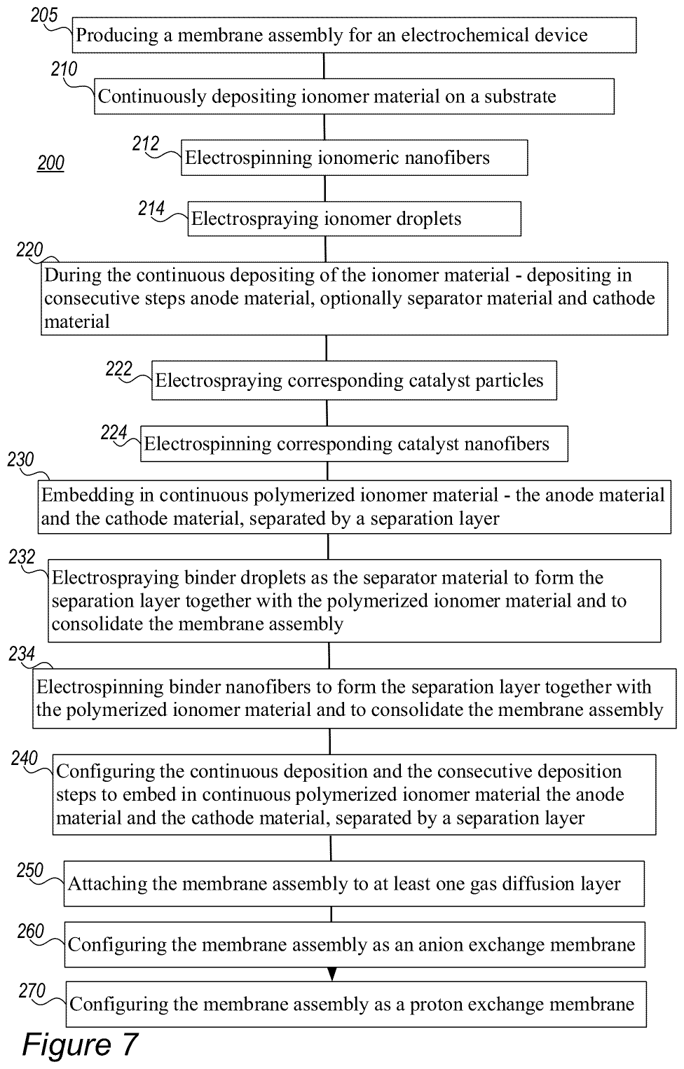

FIG. 7 is a high-level flowchart illustrating a method 200, according to some embodiments of the invention. The method stages may be carried out with respect to system 150 described above, which may optionally be configured to implement method 200. Method 200 may be at least partially implemented by at least one computer processor, e.g., in controller 170. Certain embodiments comprise computer program products comprising a computer readable storage medium having computer readable program embodied therewith and configured to carry out the relevant stages of method 200. Method 200 comprises producing a membrane assembly for an electrochemical device (stage 205) and may comprise the following stages, irrespective of their order.

Method 200 comprises continuously depositing ionomer material on a substrate (stage 210) and, during the continuous depositing of the ionomer material, depositing in consecutive steps anode material, optionally separator material and cathode material (stage 220). Continuous deposition 210 and the consecutive deposition steps 220 may be configured (stage 240) to embed in continuous polymerized ionomer material the anode material and the cathode material, separated by a separation layer (stage 230).

In various embodiments, continuous deposition 210 comprises electrospinning ionomeric nanofibers (stage 212) and consecutive deposition steps 220 comprise electrospraying corresponding catalyst particles (stage 222). Method 200 may further comprise electrospraying binder droplets as the separator material to form the separation layer together with the polymerized ionomer material and to consolidate the membrane assembly (stage 232).

In various embodiments, continuous deposition 210 comprises electrospraying ionomer droplets (stage 214) and consecutive deposition steps 220 comprise electrospinning corresponding catalyst nanofibers (stage 224). Method 200 may further comprise electrospinning binder nanofibers to form the separation layer together with the polymerized ionomer material and to consolidate the membrane assembly (stage 234).

Method 200 may further comprise attaching the membrane assembly to at least one gas diffusion layer (stage 250). Method 200 may further comprise configuring the membrane assembly as an anion exchange membrane (AEM) of a respective AEM electrochemical device (stage 260), e.g., comprising an electrolyzer or a fuel cell. Method 200 may further comprise configuring the membrane assembly as a proton exchange membrane (PEM) of a respective PEM electrochemical device (stage 270), e.g., comprising an electrolyzer or a fuel cell.

Method 200 may comprise fabricating membrane electrode assemblies by simultaneously depositing the ionomer and a first catalyst containing ink to form a first electrode which may be deposited on a GDL or on any other substrate. The ionomer may be contiguously deposited using electrospinning and the first catalyst containing ink may be deposited as droplets using electro-spraying.

Method 200 may comprise fabricating membrane electrode assemblies by simultaneously depositing the ionomer, e.g., by electrospinning and the binder dispersion, e.g., by electro-spraying, or vice versa, on top of the first electrode. In some embodiments, both the ionomer and the binder dispersion may be deposited by electrospinning or by electro-spraying, and possibly both the ionomer and the binder dispersion may be deposited in a single mixed dispersion.

Method 200 may comprise simultaneously depositing the ionomer and the second catalyst containing ink on top of the membrane, by electrospinning, electrospraying, or a combination thereof.

FIG. 8 is a high-level schematic illustration of a self-refueling power-generating system 300 with reversible AEM devices 310, according to some embodiments of the invention. FIG. 9 is a high-level flowchart illustrating a method 400 of operating self-refueling power-generating systems, according to some embodiments of the invention.

As illustrated schematically in FIG. 8, self-refueling power-generating system 300 comprises one or more reversible AEM device 310 comprising, e.g., one or more electrochemical cell stacks with membrane assemblies 100. System 300 further comprises a controller 301 configured to determine operation of reversible AEM device 310 in a fuel cell mode (as fuel cell 90A) or in an electrolyzer mode (as electrolyzer 90B). Controller 301 may comprise one or more processor(s) associated with respective memory and interfaces to the following units.

Self-refueling power-generating system 300 further comprises an oxidant unit 330 configured to supply oxygen or air to reversible AEM device 310 when operated as fuel cell, and optionally receive oxygen or air from reversible AEM device 310 when operated as an electrolyzer. Optionally, oxidant unit 330 may comprise an oxygen tank 332 for storing oxygen and may comprise a compressor 334 for compressing oxygen received from AEM device 310 into oxygen tank 332. Alternatively, oxygen compression may be provided by AEM device 310 during hydrogen generation.

Self-refueling power-generating system 300 further comprises a hydrogen unit 350 configured to supply hydrogen to reversible AEM device 310 when operated as fuel cell, and optionally receive hydrogen from reversible AEM device 310 when operated as an electrolyzer. Optionally, hydrogen unit 350 may comprise a hydrogen tank 352 for storing hydrogen and may comprise a compressor 354 for compressing hydrogen received from AEM device 310 into hydrogen tank 352. In electrolyzer mode, the generated hydrogen may be passed through a drying unit (not shown) and compressed, optionally electrochemically within AEM device 310, or optionally with the use of a mechanical, electrochemical or other compressor 354.

Self-refueling power-generating system 300 further comprises a water unit 340 configured to supply water to reversible AEM device 310. Water unit 340 may comprise a radiator 342 for dissipating heat and condensing water from AEM device 310 in the fuel cell mode, a liquid/gas separation module 344 for removing gases such as oxygen from the fluids received from AEM device 310 and a water pump 346 for pumping water to AEM device 310. The water circulation may be controlled to maintain the optimal operation temperatures in the fuel cell and electrolyzer modes.

In certain embodiments, gas/liquid separation module 344 may be configured to deliver separated oxygen from reversible AEM device 310 (produced in electrolyzer mode) to oxidant unit 330, e.g., to compressor 334. Water circulation may be provided directly to the oxygen side of AEM device 310 and the water may optionally be made alkaline by the addition of KOH or other alkaline salt, which may improve performance of AEM device 310. By combining the water and oxygen in the oxygen electrode, local relative humidity may be fixed at 100% due to the presence of excess liquid water. It is noted that while water consumption in electrolyzer mode and water production in fuel cell mode of AEM device 310 balance each other, some addition of water may be required due to system losses. A balance between oxygen and water supply may be controlled by controller 301 to optimize fuel cell performance, e.g., by using pure oxygen, and/or hydrophobizing or partially hydrophobizing the oxygen side catalyst layer and/or diffusion medium in membrane assembly 100, to preserve some areas free or partially free of liquid water and thereby allowing good access of the reactant oxygen to the catalyst surface.

Self-refueling power-generating system 300 further comprises a power connection 320 configured to receive power from reversible AEM device 310 when operated in the fuel cell mode, e.g., as power output 325; and to deliver power to reversible AEM device 310 when operated in an electrolyzer mode, e.g., as power input 326. Power connection 320 may be configured to deliver the received power to an external load when required, and to receive power for delivery from an external source when available.

As illustrated schematically in FIG. 9, self-refueling power-generating system 300 may be operated according to method 400, e.g., with controller 301 operating reversible AEM device 310, power connection 320, oxidant unit 330, water unit 340 and hydrogen unit 350 accordingly. Certain embodiments comprise computer program products comprising a computer readable storage medium having computer readable program embodied therewith and configured to carry out the relevant stages of method 400, e.g., via controller 301.

Method 400 may comprise selecting the operation mode of reversible AEM device 310 as fuel cell mode if energy is required by an external load, or as electrolyzer mode if external power is available (stage 410) and if the hydrogen tank(s) is not full (stage 412). Otherwise, electrolyzer mode is not operated (stage 415). In electrolyzer mode, the amount of hydrogen required to fill the hydrogen tank(s) may be calculated (stage 420) and accordingly a filling time and/or an electrolysis efficiency may be determined (stage 422) and compared to the availability of external power (stage 430). If sufficient power and time are available, electrolysis may be carried out with AEM device 310 at electrolyzer mode, e.g., at a maximal operation point (stages 432, 440) until the hydrogen tanks are full, otherwise an alert may be sent to the consumer (stage 434). Hydrogen production in electrolyzer mode may be set at times when external power is at high availability and/or at low price, to ensure cost effectiveness and availability of hydrogen for operating AEM device 310 at fuel cell mode when power is required.

Method 400 may be used to determine the operating point of the electrolyzer mode of self-refueling power-generating system 300, allowing the consumer to optimize hydrogen effective cost versus system fueling requirements. Based on the hydrogen level following the operation in fuel cell mode; the acceptability of any of the filling time, the electrolysis efficiency, the hydrogen refueling rate and/or available power; and required hydrogen refueling parameters, method 400 may optimize operation of system 300 in electrolyzer mode. This approach takes advantage of the expected low frequency of use for power generation relative to what would otherwise be idle time. Operating system 300 for hydrogen recharging using much lower power than the nominal power generation capacity means the performance requirements for the hydrogen (and oxygen) generation are strongly mitigated, allowing minimal if any compromise on performance of the power generation direction of the hydrogen exchange.

Advantageously, in use examples such as backup power scenarios, the most common operations would be to use a small portion of the available hydrogen. Given a reasonably predictable frequency of power outages, system 300 may automatically run electrolysis at close to maximum efficiency and minimum refueling rate, and still expect the tanks to be full before the next outage. In use examples where power availability may be critical, the algorithm of method 400 may be optimized to refuel to some minimum critical amount of fuel at the maximum available rate, then run at maximum efficiency for the remaining refueling process. In use examples where cost of power supplied to the system for electrolysis is critical, system 300 may be configured to operate at maximum electrolysis efficiency. In examples use where system 300 is to be used next at a known future time, for example in some cases for portable power generation devices, the electrolysis operation could be fixed to a rate that delivers full tanks by an acceptable time ahead of the known next use.

Elements from FIGS. 1-9 may be combined in any operable combination, and the illustration of certain elements in certain figures and not in others merely serves an explanatory purpose and is non-limiting.

Advantageously, disclosed membrane assemblies may be fabricated in a single continuous process, providing good control of the microstructure of the electrodes (e.g., by controlling ink composition and process parameters) and avoiding issues relating to interfaces between layers—to optimize the electrochemical and physical processes simultaneously. For example, electrolyzers using the disclosed membrane assemblies may be more robust to hydrogen and oxygen gas crossover while maintaining good conductivity over their operation duration.

Moreover, disclosed membrane assemblies are reinforced due to their fabrication processes, and improve membrane dimensional stability (less swelling) and membrane mechanical properties (less brittle) in addition to their reducing of gas crossover.

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram or portions thereof.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram or portions thereof.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram or portions thereof.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A membrane assembly for an electrochemical device, the membrane assembly comprising at least an anode layer, a separation layer and a cathode layer that are all embedded in continuous polymerized ionomer material.

2. The membrane assembly of claim 1, wherein the ionomer material comprises electrospun nanofibers and the anode and cathode layers comprise corresponding electrosprayed catalyst particles.

3. The membrane assembly of claim 2, further comprising electrosprayed binder droplets forming the separation layer together with the polymerized ionomer material and consolidating the membrane assembly.

4. The membrane assembly of claim 1, wherein the ionomer material comprises electrosprayed ionomer droplets and the anode and cathode layers comprise corresponding electrospun catalyst nanofibers.

5. The membrane assembly of claim 4, further comprising electrospun binder nanofibers forming the separation layer together with the polymerized ionomer material and consolidating the membrane assembly.

6. The membrane assembly of claim 1, attached to at least one gas diffusion layer.

7. The membrane assembly of claim 1, configured as an anion exchange membrane (AEM) of a respective AEM electrochemical device comprising an electrolyzer or a fuel cell.

8. The membrane assembly of claim 7, wherein the AEM electrochemical device is a fuel cell and wherein:
the anode layer is 2 μm to 30 μm thick, has an ionomer content of between 5% w/w and 40% w/w and is made of oxophilic material,
the separation layer is 5 μm to 30 μm thick, and has a conductance larger than 10 S·cm⁻², and
the cathode layer is 10 μm to 30 μm thick, has an ionomer content of between 1% w/w and 40% w/w and is made of oxygen reducing material.

9. The membrane assembly of claim 7, wherein the AEM electrochemical device is an electrolyzer and wherein:
the anode layer is 5 μm to 50 μm thick and is made of metallic Ni, Fe, Ir, and/or Pt, and/or oxides thereof,
the separation layer is 10 μm to 100 μm thick, and has a conductance larger than 5 S·cm⁻², and
the cathode layer is 1 μm to 20 μm thick and is made of oxophilic material.

10. The membrane assembly of claim 1, configured as a proton exchange membrane (PEM) of a respective PEM electrochemical device comprising an electrolyzer or a fuel cell.

11. An electrolyzer comprising the membrane assembly of claim 7.

12. A fuel cell comprising the membrane assembly of claim 7.

13. A reversible AEM device comprising the membrane assembly of claim 7 and configured to be operated alternately as a fuel cell and as an electrolyzer.

14. The reversible AEM device of claim 13, wherein
the anode layer of the fuel cell mode operates as the cathode layer in the electrolyzer mode and is 2 μm to 20 μm thick and is made of oxophilic material,
the separation layer is 10 μm to 30 μm thick, and has a conductance larger than 10 S·cm⁻², and
the cathode layer of the fuel cell mode operates as the anode layer in the electrolyzer mode and is 10 μm to 30 μm thick and is made of oxygen reducing material.

15. A self-refueling power-generating system comprising:
the reversible AEM device of claim 13,
a controller configured to determine operation of the reversible AEM device in a fuel cell mode or in an electrolyzer mode,
an oxidant unit configured to supply oxygen or air to the reversible AEM device when operated as fuel cell, and optionally receive oxygen or air from the reversible AEM device when operated as an electrolyzer,
a hydrogen unit configured to supply hydrogen to the reversible AEM device when operated as fuel cell, and optionally receive hydrogen from the reversible AEM device when operated as an electrolyzer,
a water unit configured to supply water to the reversible AEM device, and
a power connection configured to receive power from the reversible AEM device when operated in the fuel cell mode, and deliver power to the reversible AEM device when operated in an electrolyzer mode, wherein the power connection is configured to deliver the received power to an external load when required, and to receive power for delivery from an external source when available.

16. The self-refueling power-generating system of claim 15, wherein:
the oxidant unit is configured to supply oxygen to the reversible AEM device when operated as fuel cell and to receive oxygen from the reversible AEM device when operated as an electrolyzer,
the water unit comprises a gas/liquid separation module configured to deliver separated oxygen from the reversible AEM device to the oxidant unit, and
the hydrogen unit is configured to receive hydrogen from the reversible AEM device when operated as an electrolyzer.

17. A method of producing a membrane assembly for an electrochemical device, the method comprising:
continuously depositing ionomer material on a substrate, and
during the continuous depositing of the ionomer material, depositing in consecutive steps anode material, optionally separator material and cathode material,
wherein the continuous deposition and the consecutive deposition steps are configured to embed in continuous polymerized ionomer material the anode material and the cathode material, separated by a separation layer.

18. The method of claim 17, wherein the continuous deposition comprises electrospinning ionomeric nanofibers and the consecutive deposition steps comprise electrospraying corresponding catalyst particles, and optionally
further comprising electrospraying binder droplets as the separator material to form the separation layer together with the polymerized ionomer material and to consolidate the membrane assembly.

19. The method of claim 17, wherein the continuous deposition comprises electrospraying ionomer droplets and the consecutive deposition steps comprise electrospinning corresponding catalyst nanofibers, and optionally
further comprising electrospinning binder nanofibers to form the separation layer together with the polymerized ionomer material and to consolidate the membrane assembly.

20. A system of fabricating membrane assemblies for an electrochemical device, the system comprising:
at least one deposition unit configured to continuously deposit ionomer material on a substrate, and
at least one deposition unit configured to deposit in consecutive steps, during the continuous depositing of the ionomer material: anode material, optionally separator material and cathode material,
wherein the continuous deposition and the consecutive deposition are configured to embed the anode material and the cathode material, separated by a separation layer—in continuous polymerized ionomer material.
